(19) United States
(12) Patent Application Publication
(10) Pub. No.: US 2019/0129734 A1
(43) Pub. Date: May 2, 2019

(54) DATA COLLECTION WORKFLOW EXTENSION

(71) Applicant: CA, Inc., New York, NY (US)

(72) Inventors: Yang Yang, Newton, MA (US); Zubing Robin Qin, Southborough, MA (US); Fei Gu, Newton, MA (US)

(21) Appl. No.: 15/800,019

(22) Filed: Oct. 31, 2017

(51) Int. Cl. G06F 9/445; G06F 9/44

(52) U.S. Cl. CPC G06F 9/44526; G06F 9/443

(57) ABSTRACT

Techniques and systems are disclosed for implementing program extensions. A plugin is instantiated from a class definition object and a plugin interface template. The plugin interface template is a markup language object describing and internally associated with the class definition object. The instantiating includes reading the plugin interface template to determine the template-to-object association and, based on the association, the class definition object and the plugin interface template are stored within a execution memory space of a plugin interface. A plugin interface executes the plugin including in response to a data collection request specifying a plugin ID and one or more input data parameters and one or more method parameters, accessing one or more method objects that are specified by a script language method object defined by the class and that correspond to the method parameters, and executing at least one of the one or more method objects using the input data parameters.

### BACKGROUND

The disclosure generally relates to the field of data processing, and more particularly to processing data collection workflows.

Workflow processing is implemented by processing and communications systems for many purposes including collecting data from various data sources such as various databases. Some data collection systems include user interfaces (UIs) for initiating and formulating data collection requests. In such systems, a data collection request is received and processed by each of potentially many data sources each having different host applications that employ mutually distinct transaction protocols and data storage schemas and are consequently accessed via different data collection application program interfaces (APIs). The data collection functions available to a requesting client are limited to those native to the respective host applications and also to plugins having compatible API interfaces. Data collection systems face significant integration efficiency (i.e., ability to centrally manage multiple different data sources) as well as processing efficiency issues incident to the vast and expanding numbers of different data organization and storage formats and protocols.

### BRIEF DESCRIPTION OF THE DRAWINGS

Embodiments of the disclosure may be better understood by referencing the accompanying drawings.

FIG. 1 is a block diagram depicting subsystems, devices, and components within a system for implementing data collection extensions in accordance with some embodiments;

FIG. 2A depicts an example class definition file that may be utilized for implementing data collection extensions in accordance with some embodiments;

FIG. 2B illustrates an example plugin interface template that may be utilized for implementing data collection extensions in accordance with some embodiments;

FIG. 2C depicts an example data collection program code representing a data collection workflow that includes an inserted data collection plugin call in accordance with some embodiments;

FIG. 3 is a block diagram illustrating subsystems, devices, and components within a system for implementing runtime generation and execution of data collection extensions in accordance with some embodiments;

FIG. 4 is a flow diagram illustrating operations and functions performed to generate data collection plugins in accordance with some embodiments;

FIG. 5 is a flow diagram depicting operations and functions for generating and otherwise processing data collection requests in accordance with some embodiments;

FIG. 6 is a flow diagram illustrating operations and functions performed as part of a data collection cycle to implement data collection workflow extensions in accordance with some embodiments; and

FIG. 7 is a block diagram depicting an example computer system that generates and implements data collection plugins in accordance with some embodiments.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

### INTRODUCTION

The disclosed embodiments implement plugin-type extensions (referred to herein also as plugin extensions or plugins) such as user-defined extensions independently of the APIs utilized by the program for which the extensions are utilized. In some aspects, the operations and components of the embodiments utilize different categories of “program” constructs. In some embodiments, markup language templates are configured to interface with class definition objects enabling instantiation and execution of corresponding user-defined plugins. As utilized herein a “markup language” is generally characterized as including tags and other interpretable structures that control the presentation of data but do not transform data. The tags are used to “mark-up” documents so that portions of the document are presented, such as for display on a display device, in a particular manner. Example markup languages include XML and HTML.

As utilized herein, a “programming language” is structured such that when executed, the program generated using the programming language transforms data and is therefore categorically distinct from “markup language.” Programming languages include compiled program languages (e.g., C++, Java, etc.) and script languages (e.g., Groovy, Python, etc.). As utilized herein, a “scripting language” or “script language” is a programming language configured to operate to mediate between other programming languages. A key feature of script languages is that they are interpreted at run-time by a separate program which is usually a compiled (i.e., pre-interpreted/translated into machine language) program language program.

### Overview

Embodiments disclosed herein include a system that generates plugin generation and implementation components including class definition objects, plugin interface templates, and plugin wrapper for adapting script language classes and/or corresponding class objects to different data collection workflow interfaces which may include respective native API code. In some embodiments, a code development tool is utilized to generate a script language class definition object that defines a class that specifies properties of program language objects. Among the specified program language objects is a method object that defines a script language operations corresponding to compiled program language methods to be performed with respect to data input and method parameters. The method parameters comprise method IDs corresponding to the compiled program language methods.

A markup language generation tool may be utilized to generate a plugin interface template corresponding to a given script language class definition object. In some embodiments, the plugin interface template comprises a markup language object, such as an XML file, that includes fields specifying a plugin name and corresponding plugin description. A browser or other program can be utilized to interpret the XML code to display the plugin description in association with the plugin name. The plugin interface template further includes tagged elements that specify an association, or link, with a script language class definition object ID. The tagged elements further include an input list comprising one or more input data parameters and method parameters. In some embodiments, the input list elements are configured to implement a logical mapping between plugin interface template input data parameters and class definition object input data parameters. The input list elements may be further configured to implement a logical mapping between plugin interface template method parameters and class definition object method parameters.

The class definition objects and corresponding plugin interface templates may be stored in a common work directory where they are accessed and otherwise processed by a plugin processing components such as a plugin generator and a plugin interface. During a data collection cycle, the plugin generator identifies a class definition object and corresponding plugin interface template and, in response, instantiates a corresponding data collection plugin execution instance. The plugin interface may include a plugin wrapper and plugin engine that process data collection requests to execute the data collection plugin based during data collection workflow cycles as further explained with reference to the Figures.

Example Illustrations

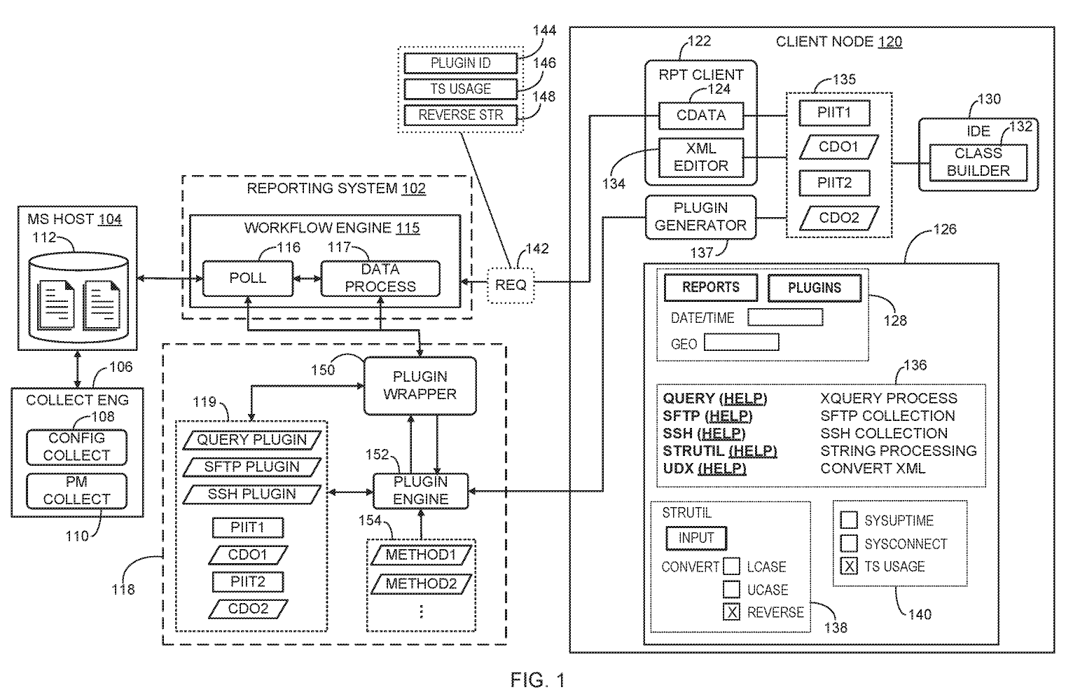

FIG. 1 is a block diagram depicting subsystems, devices, and components within a system for implementing data collection extensions in accordance with some embodiments. As depicted, the system includes a reporting system 102 communicatively coupled to a monitoring system host 104. Reporting system 102 is generally configured, using any combination of hardware and program code, to collect infrastructure management information from monitoring system host 104. The infrastructure management information may include configuration information for a target system such as device/component names and associated functional configuration information. The infrastructure management information may also include performance metrics for the devices/components identified by the configuration information. In the depicted example, monitoring system host 104 is communicatively coupled to a collection engine 106 that directly collects, such as by polling, the configuration information and performance metrics data using a configuration collection tool 108 and a performance metric collection tool 110. Monitoring system host 104 retrieves and stores the configuration information and performance metrics data in a structured data storage component 112, which may comprise a database.

Reporting system 102 is programmably configured to selectively retrieve information from monitoring system host 104 in accordance with client requests such as may be received from a client node 120. Reporting system 102 includes a workflow engine 115 that is configured using any combination of hardware and program code to interface with a report client application 122 within client node 120. Workflow engine 115 is an application including a poll component 116 that collects infrastructure management information from monitoring system host 104 such as during scheduled polling cycles and/or in response to calls from client node 120. To this end, workflow engine application 115 comprises a data process component 117 that processes requests such as data collection requests generated by report client 122. For instance, data process component 117 may be configured to, in response to a client data collection request, process data (e.g., query) that is collected by poll component 116.

The requests generated by data collection program 124 comprises program constructs and data structures that conform to the protocol and schema used by the components of workflow engine 115. Program extensions, such as may be implemented by plugins requested by data collection program 124 can only be directly executed by workflow engine 115 using an application program interface (API) that conforms to API's utilized by the report server 117 and/or poll application 116 components of workflow engine 115. The reliance on API's and other program schema conformity may substantially reduce the opportunity, flexibility, and efficiency with which data collection program extensions can be utilized in a run-time processing environment. In terms of efficiency, a client such as a user may be required to generate a given extension plugin using one of several particular programming languages in a manner conforming to one of the APIs implemented by workflow engine 115. Furthermore, a program language plugin extension may need to be compiled and the overall system (e.g., reporting system 102) may need to be rebooted to functionally integrate new plugin(s).

The depicted system further includes components and data structures that may be utilized as described to enable user defined workflow extensions to be efficiently and flexibly implemented during system run-time. The components include components for generating interface objects and script language class definition objects that enable clients to create new plugin extension definitions independently of the programming language schema and API interfaces used by workflow engine 115. In the depicted embodiment, client node 120 includes an integrated development environment (IDE) system 130 for generating script language objects. IDE system 130 generally comprises a code development application configured to implement code development facilities such as a source code editor and debugger. In the depicted embodiment, IDE system 130 comprises a code development application in the form of a class builder 132.

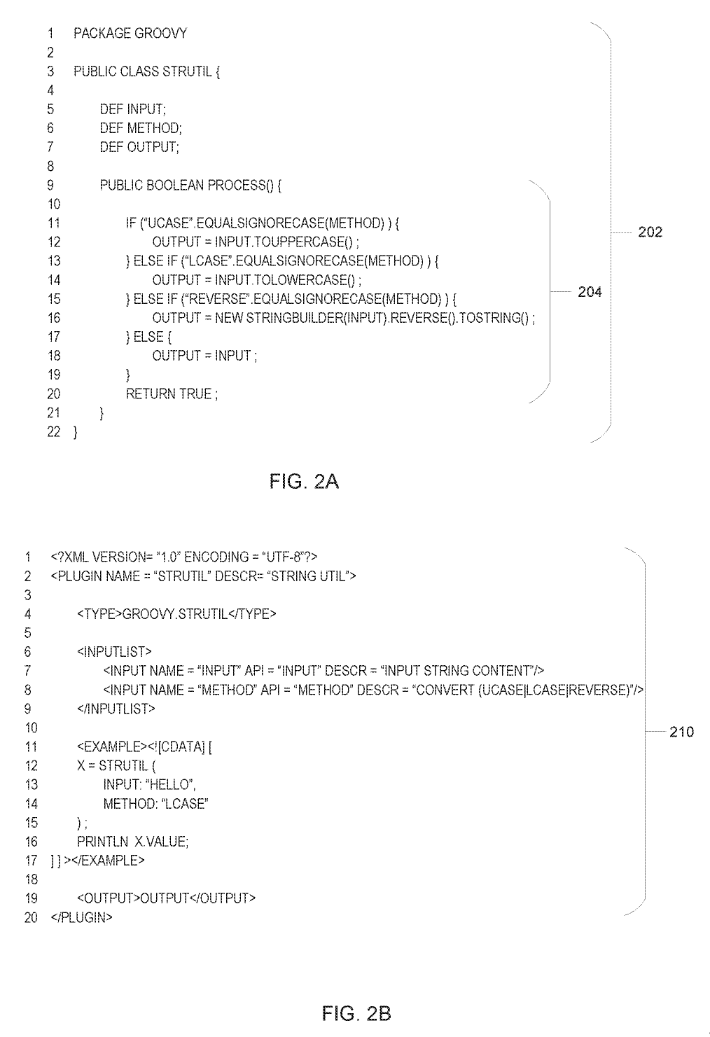

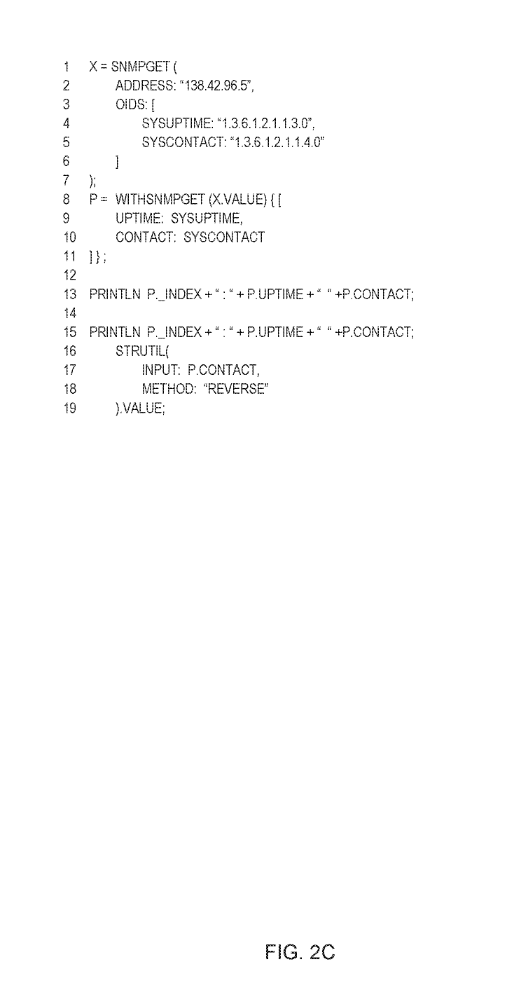

Class builder 132 is configured, using any combination of program code and data to generate script language constructs, such as class definition objects, in accordance with input from a user interface within client node 120. Based on UI input, class builder 132 generates class definition objects such as class definition object 202 illustrated in FIG. 2A. As depicted, class definition object 202 includes a class definition “Package Groovy” at line 1 that defines the object as a groovy script language object. Class definition object 202 further includes a class object name “STRUTIL” defined at line 3. Following the class object name, class definition object 202 defines a set of program language parameters objects, “INPUT,” “METHOD,” and “OUTPUT” to be used, as explained in further detail herein, by compiled program language methods during plugin execution.

The defined programming language parameter objects “INPUT,” “METHOD,” and “OUTPUT” are incorporated as script language parameters within a script language method object 204 having method name “PROCESS.” In the depicted embodiment, the PROCESS method defined by method object 204 includes multiple conditional statements that determine the value of the “OUTPUT” parameter object based on the processing of multiple compiled programming language methods. The compiled programming language methods each correspond to a method object contained within each of the conditional statements. For example, lines 11 and 12 specify the value of the “OUTPUT” parameter object to be “INPUT.TOUPPERCASE(METHOD) on the condition (i.e., “if”) “UCASE” was received as an input method parameter in a data collection request. As specified at lines 15 and 16, the value of the “OUTPUT” parameter object to be “INPUT.TOUPPERCASE(METHOD) if “REVERSE” was received as an input method parameter in a data collection request.

Returning to FIG. 1 in conjunction with FIG. 2A, IDE system 130 stores class definition objects such as class definition object 202 as one of class definition object instances CDO1 or CDO2 within a memory 135 of client node 120. To provide a flexible and program language/API independent interface for generating newly configured plugins, client node 120 further includes means for generating plugin interface templates in the form of markup language objects. In the depicted embodiment, such means are embodied, in part, by an XML editor 134 that may be integrated within report client 122. XML editor 134 comprises any combination of program code and data configured to generate XML code in accordance with UI input. Specifically, XML editor 134 may be utilized to generate markup language objects/files configured as plugin template interface objects that correspond to class definition objects such as CDO1 and CDO2 within memory 135.

FIG. 2B illustrates an example plugin interface template 210 that may be generated by XML editor 134 and utilized for implementing a data collection plugin extension in accordance with some embodiments. Plugin interface template 210 includes markup language elements and fields that can be utilized by plugin processing components to call a corresponding script language class definition object, which can then be utilized to implement compiled programming language methods. As shown in FIG. 2B, plugin interface template 210 includes a root element at line 1 that defines the file/object type as XML followed at line 2 by a plugin name element that defines the plugin name as “STRUTIL.” Plugin name “STRUTIL” is the plugin name that will be used in a collection workflow expression, such as the workflow expression shown in FIG. 2C. Also included in line 2 is a description element “DESCR” that is associated within the same parent element with the plugin name and is set to the text string value “STRING UTIL.” The name-to-description association enables a data collection user interface within client node 120 to display the description string in association with the plugin name in response to the plugin name being selected by a UI input.

At line 4, plugin interface template 210 includes a link element, tagged as “TYPE,” that specifies the plugin as corresponding to a particular script language class, groovy, and class definition object, “STRUTIL” depicted in FIG. 2A. Plugin interface template 210 further includes elements that maps XML parameters to script language (e.g., groovy) parameters. At lines 6-9, plugin interface template 210 includes an input list element comprising two input elements. One of the input elements maps a program data input parameter variable to a data input parameter variable specified by the class defined by class definition object 202 in FIG. 2A. Specifically, line 7 includes an input element that maps the workflow name “Input” to the API input data parameter name “Input.” The input element in the input list maps a program method variable to a method variable specified by the class defined by class definition object 202. Specifically, line 8 includes an input element that maps the workflow method name “Method” to the API method name “Method.”

At lines, 11-17, plugin interface template 210 further includes an example element tagged as “Example.” In response to a UI selection of the plugin name, the data collection UI displays the example lines shown as display text at lines 12-14 within a displayed object such as a plugin assistance object. Plugin interface template 210 further defines an output element “OUTPUT” that defines which variable will be returned when the plugin corresponding to plugin interface template is executed.

Returning to FIG. 1 in conjunction with FIGS. 2A and 2B, report client 122 stores plugin interface templates such as plugin interface template 210 within memory 135 (e.g., as PIIT1, PIIT2). Client node 120 further includes components for instantiating plugins corresponding to class definition objects and plugin interface templates so that the plugins may be utilized during data collection cycles. Client node 120 includes a plugin generator application 137 that is configured using any combination of program and data constructs to perform a portion of plugin instantiation. In some embodiments, plugin generator 137 reads the class definition objects such as CDO1 and CDO2 and plugin interface templates such as PIIT1 and PIIT2 to determine associations between the plugin interface templates and corresponding class definition objects. Consider, for instance, an example in which CDO1 represents class definition object 202 and PIIT1 represents plugin interface template 210. Plugin generator may read PIIT1 to determine an association between PIIT1 and CDO1 based on the link element <TYPE>GROOVY.STRUTIL</TYPE>.

Having determined the association, plugin generator 137 continues the instantiation cycle by sending PIIT1 and CDO1 to be stored within a memory of a plugin interface 118. For example, a plugin engine 152, which may be a Java virtual machine (JVM) within plugin interface 118, may receive and store PIIT1 and CDO1 within an execution memory space 119 of plugin interface 118. Plugin interface 118 is configured using any combination of hardware and program code to perform plugin processing including portions of instantiation and execution of plugins generated from class definition objects and plugin interface templates. These components include plugin engine 152 and a plugin wrapper 150 that is communicatively coupled to plugin engine 152 and workflow engine 115.

Following instantiation of a given class definition object and associated plugin interface template, plugin interface 118 may be called by workflow engine 115 during data collection runtime to execute a corresponding plugin. Plugin execution may begin with a data request generated by data collection program 124. In the depicted embodiment, data collection program 124 includes a UI component represented in FIG. 1 as a data collection UI 126. Input may be received via the objects displayed within data collection UI 126 and utilized to generate a corresponding data collection request that may be or at least include a plugin call. As shown, data collection UI 126 includes a data input object 128 that displays input select objects REPORTS and PLUGINS in addition to text input objects comprising text input boxes corresponding to DATE/TIME and GEO labels. In response to input selection (e.g., input pointer device selection) of the PLUGINS select object, data collection UI 126 displays a plugin list object 136.

As shown, plugin list object 136 comprises a displayed list of the names of plugins including QUERY, SFTP, SSH, STRUTIL, and UDX. One or more of the plugin names correspond, such as STRUTIL, correspond to plugin interface templates. Others of the plugin names may correspond to plugins comprising compiled program language constructs. Each of the plugin names displayed within list object 136 is an active, selectable object and is further associated with a respective selectable HELP object. In response to selecting a HELP object, data collection UI 126 displays one or more objects (not depicted) such as an assistance object that display the example information encoded within the corresponding plugin interface template. Each of the displayed plugin names is further associated with a text description of the plugin function encoded within the corresponding plugin interface template (e.g., STRING PROCESSING for STRUTIL).

A plugin execution cycle may continue with data collection UI 126 displaying a plugin object 138 in response to an input selection of the STRUTIL object within list object 136. Plugin object 138 includes an input list selection object INPUT that in response to selection results in data collection UI 126 displaying a selection menu 140 of data input options. Plugin object 138 further includes a method selection object CONVERT that includes three selectable method select options LCASE, UCASE, and REVERSE. As depicted, the time series (TS) usage data input option and REVERSE method have been selected and in response data collection program 124 generates a data collection request 142 in the form of a plugin call. Data collection request 142 specifies a plugin ID 144 that is included in the plugin interface template corresponding to the selection of the STRUTIL object within object list 136. Data collection request 142 further includes data input parameters and method parameters and in the depicted example, a time series usage input data parameter 146 and a reverse string method parameter 148 to the input selections within objects 138 and 140.

The plugin execution cycle continues with request 142 being received by report component 117 within workflow engine 115. In response to request 142, report component 117 calls plugin wrapper 150 using the plugin name from request 142. Plugin wrapper 150 includes program code configured to call plugins from memory space 119 in response to calls from either report component 117 or poll component 116. As shown, memory space 119 includes a number of pre-compiled programming language plugins including QUERY, SFTP, and SSH that have API's conforming the API interface for report component 117. In response to a collection request that is or includes a call to one of the pre-compiled plugins, plugin wrapper calls the corresponding plugin (e.g., QUERY) which is then directly executed by report component 117.

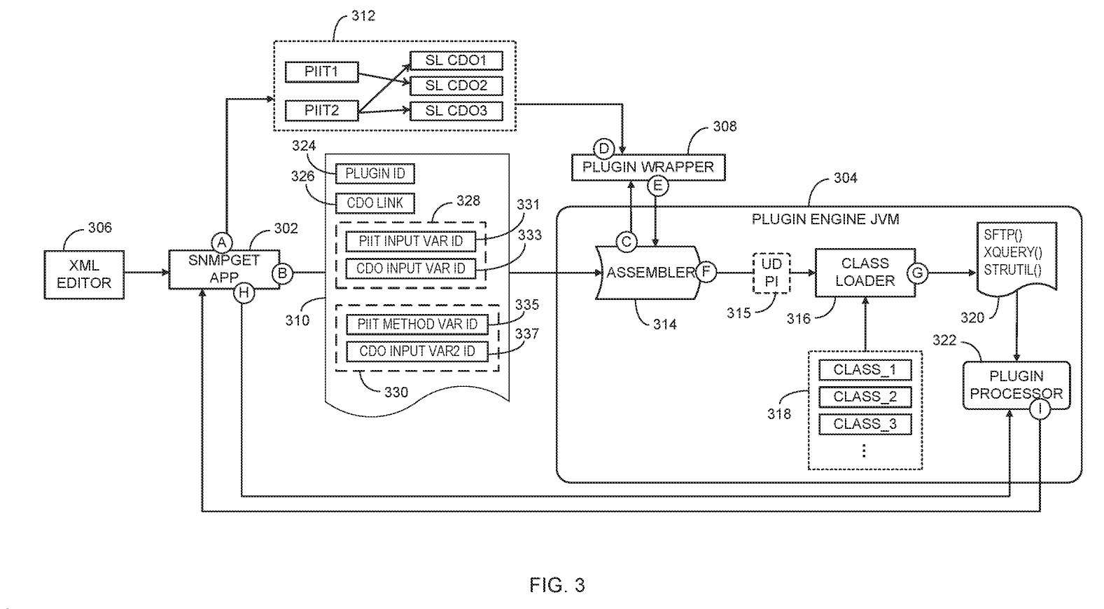

Continuing with the example execution cycle for a plugin corresponding to a plugin interface template, plugin wrapper 150 utilizes the association with the plugin name to identify and call the corresponding class definition object instance, such as CDO1 within memory space 119. In contrast to the execution sequence for pre-compiled program language plugins, plugin wrapper 150 calls the class definition object to be executed by a script language processor (not expressly shown in FIG. 1) within plugin engine 152. As depicted and described in further detail with reference to FIG. 3, plugin engine 152 executes the plugin corresponding to a script language class definition object and associated plugin interface by calling and executing compiled program methods from a methods set 154. The methods called and executed correspond to method objected encoded within a script language method within the class definition object.

FIG. 3 is a block diagram illustrating subsystems, devices, and components within a system for implementing runtime generation and execution of data collection extensions in accordance with some embodiments. The components shown in FIG. 3 include a plugin engine that may be implement within the system shown in FIG. 1. The depicted system includes a data collection application 302 that is communicatively coupled with a plugin engine 304, which comprises a JVM in the depicted embodiment. Data collection application 302 may be an infrastructure management application such as a program for collecting SNMP data from a set of hardware and software devices. Data collection application 302 also incorporates or is otherwise communicatively coupled with an XML editor that is utilized to generate plugin interface templates such as those described with reference to FIG. 1. Data collection application 302 is further configured to access a memory space 312 in which class definition objects CDO1, CDO2, and CDO3 and plugin interface templates PIIT1 and PIIT2 are stored. The components within the depicted system are collectively configured to process runtime generated plugin interface templates in a manner enabling corresponding runtime generation of script language class definition objects.

FIG. 3 is annotated with a series of numbers/letters A-I that represent stages of operations. Although these stages are ordered for this example, the stages illustrate one example to aid in understanding this disclosure and should not be used to limit the claims. Subject matter falling within the scope of the claims can vary with respect to the order and some of the operations. At stage A, data collection application 302 receives and processes a plugin interface template 310 that is originally generated by XML editor 306. As part of the processing, data collection application 302 stores a copy of plugin interface template 310 within memory space 312 which is accessible by a plugin wrapper 308 as well as to data collection application 302 during runtime.

In the depicted embodiment, the copy of plugin interface template 310 stored in memory space 312 is represented as PIIT2. As described with reference to FIGS. 1 and 2B, plugin interfaces templates such as PIIT1 and PIIT2 stored within memory space 312 may include one or more elements, such as a TYPE element containing the name of a class definition object/file, that link or otherwise directly associate the plugin interface template with one or more class definition objects. The embodiment illustrated in FIG. 3 represents such links/associations as arrows pointing from PIIT1 and PIIT2 to one or more of three script language class definition objects CDO1, CDO2, and CDO3. Specifically, PIIT1 is depicted as including a link to CDO2 and PIIT2 is depicted as including a link to CDO1 and a link to CDO3.

At stage B, data collection application 302 sends plugin interface template 310 to an assembler 314 within plugin engine 304. Assembler 314 is configured using any combination of program code to read the elements and fields within markup language objects such as plugin interface template 310. Assembler 314 further includes program code for identifying particular plugin interface template elements and field values and calling corresponding class definition objects from memory space 312 in response thereto. At stage C, for example, assembler 314 reads plugin interface template 310 to determine a plugin ID value 324 and one or more class definition object links 326. The determined plugin ID value may comprise a plugin name and links 326 may comprise a class definition object name that specifies a filename for the object and also specifies a script language that the class definition object is encoded in.

In response to identifying plugin interface template 310 as not having been previously processed and determining the association between plugin ID 324 and one or more classes defined by one or more corresponding class definition objects identified via links 326, plugin wrapper 308 identifies and calls or otherwise retrieves CDO1 and CDO3 (stages D and E) from memory 312 to be processed by assembler 314. At stage F, assembler 314 reads tagged input data elements 328 and 330 within plugin interface template 310 to determine associations between template data input parameter variables and script language data input variables and associations between template method variables and script language method variables. More specifically, assembler 314 reads and associates a template input variable ID 331 with a class definition object variable ID 333 and reads and associates a template method variable ID 335 with a class definition object method variable ID 337.

Continuing at stage F, assembler 314 generates a plugin 315 comprising class definition objects CDO1 and CDO3 and sends plugin 315 to a class loader 316 that is incorporated within plugin engine JVM 304. Class loader 316 may be a Java class loader incorporated within a Java runtime environment and configured using any combination of program code to load Java classes in response to runtime requests such as from assembler 314. For example, in response to a call from data collection application 302, class loader 316 may load a compiled Java class object from a plugin directory 318 as a class definition file 320 to a plugin processor 322 within the plugin engine 304. In the depicted workflow in which assembler 314 sends the plugin 315 as part of a class load request, class loader 316 at stage G loads the plugin 315 to be processed by plugin processor 322. At stage H, data collection application 302 generates and sends a data collection request that is or includes a plugin call that includes plugin interface template variable values including template data input variable values and template method variable values. At stage I in response to the data collection request, plugin processor 322 executes loaded plugin 315 using the data input variable values and method variable values received in the request and returns the results to data collection application 302.

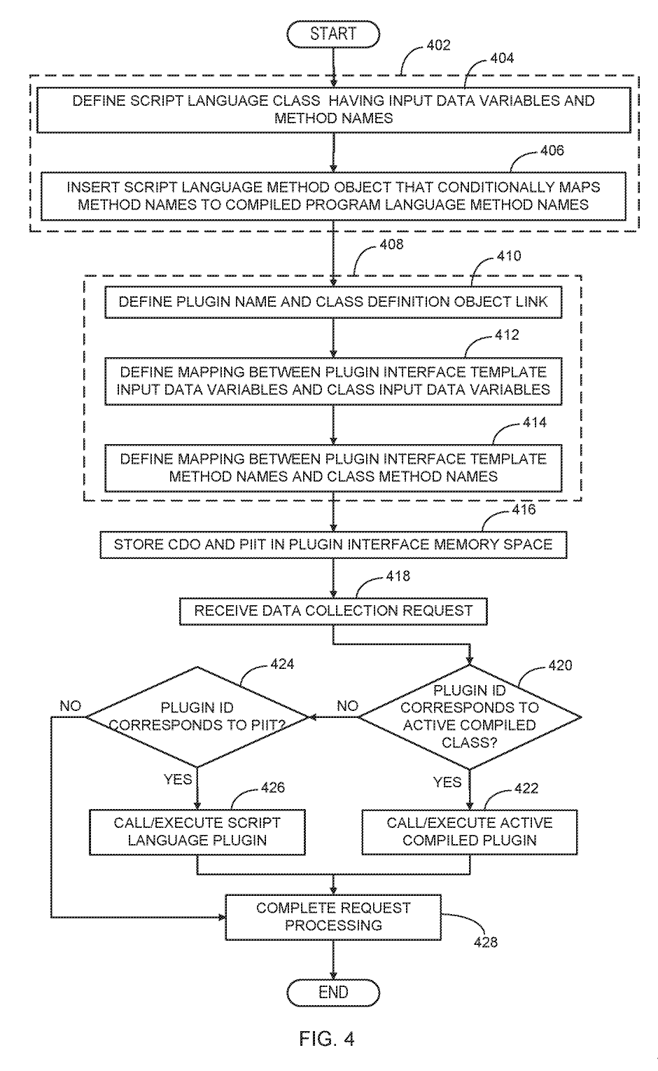

FIG. 4 is a flow diagram illustrating operations and functions performed to generate data collection plugins in accordance with some embodiments. The operations and functions depicted in FIG. 4 may be performed by one or more of the systems, devices, and components depicted and described with reference to FIGS. 1 and 3. The process begins as shown at super block 402 with a procedure for generating a script language class definition object, such as a class definition file. The class definition object generation begins at block 404 with a class builder that includes a source code generator defining within a file a script language class including defined input data variables and method names. The class builder tool completes the class definition object by inserting a script language method object that conditionally maps method names to compiled program method names (block 406).

The plugin generation process continues as shown at super block 408 with generation of a markup language file that is configured and processed as a plugin interface template. At block 410, a markup language editor is utilized to generate a markup language file that includes a plugin name/ID and a link element that contains a class definition object name/ID. At block 412, the markup language editor is utilized to define mappings between template input data variables and class-defined input data variables. The markup language editor completes the plugin interface template file at block 414 by defining mappings between template method names and class method names.

At block 416, a plugin processing facility such as a plugin generator or plugin interface stores the generated class definition object and plugin interface template in a memory space of a plugin interface that performs plugin processing such as for a data collection program. At block 418, a plugin interface, such as may be embodied by plugin interface 118 in FIG. 1 possibly in conjunction with plugin JVM 304 in FIG. 3, receives a data collection request that contains a plugin ID, one or more data input parameters, and one or more method parameters. Based on the data collection request content, the a plugin wrapper or other component within the plugin interface determines whether the plugin associated with the plugin ID is a pre-compiled program language plugin or whether the plugin ID corresponds to a plugin interface template.

As shown at blocks 420 and 422, in response to determining that the plugin ID corresponds to a compiled class object (plugin) that may or may not be currently loaded, the plugin wrapper calls the plugin which may be executed directly by a workflow engine or by a plugin processor prior to control returning at block 428 to the main data collection workflow. As shown at blocks 424 and 426, in response to determining that the plugin ID corresponds to a plugin interface template such as may be included in multiple templates stored in a template directory, the plugin wrapper calls one or more corresponding script language class definition objects and executes the class definition objects using the data input parameters and method parameters received in the request. Following plugin execution, control returns to the main workflow process as shown at block 428.

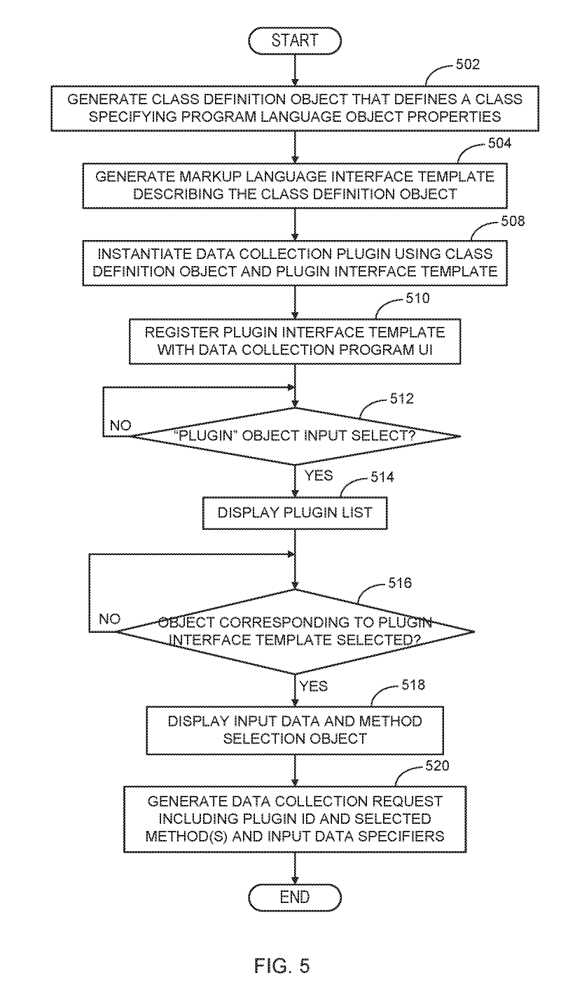

FIG. 5 is a flow diagram depicting operations and functions for generating and otherwise processing data collection requests in accordance with some embodiments. The operations and functions depicted in FIG. 5 may be performed by one or more of the systems, devices, and components depicted and described with reference to FIGS. 1 and 3. The process begins as shown at block 502 with a class builder tool generating a class definition object that defines a class specifying program language object properties. For example, the class definition object may comprise a script language file that is classified based on the script language (e.g., groovy) and specifies a class name. At block 504, a markup language editor generating, based in UI input, a plugin interface template file that describes and includes an association with the class definition object generated at block 502. For instance, the plugin interface template may include a link element that specifies the class name of the class definition object and may further include input mapping elements that map template data input variables to class data input variables and that map template method names to class method names.

The process continues as shown at block 508 with one or more plugin processing components such as those shown in FIGS. 1 and 3 instantiating a data collection plugin using the class definition object and the plugin interface template. For instance, the instantiation may be performed by a client-side plugin generator that sends the class definition object and corresponding plugin interface template to be stored in an active memory space of a plugin interface. At block 510, one or more components within a plugin interface register the plugin interface template with a data collection program UI.

The data collection UI is displayed to, for example, facilitate user configuration of data collection requests. As shown at block 512 and 514, in response to selection of a plugin object within the data collection UI, the data collection UI displays a list of available plugins including the plugin registered at block 510. Having displayed the plugin list, the UI may detect an input selection corresponding to one of the plugin objects displayed in the list. As shown at blocks 516 and 518, in response to detecting input selection of a particular plugin object within the displayed list, the data collection UI displays one or more data input and method select objects that correspond to data input variables and method names of the plugin corresponding to the selected plugin object. The data collection request generation process concludes as shown at block 520 with the data collection program that includes the data collection UI generating a data collection request message that includes a plugin ID and method and data input parameters selected based on input to the data input and method selection objects displayed at block 518.

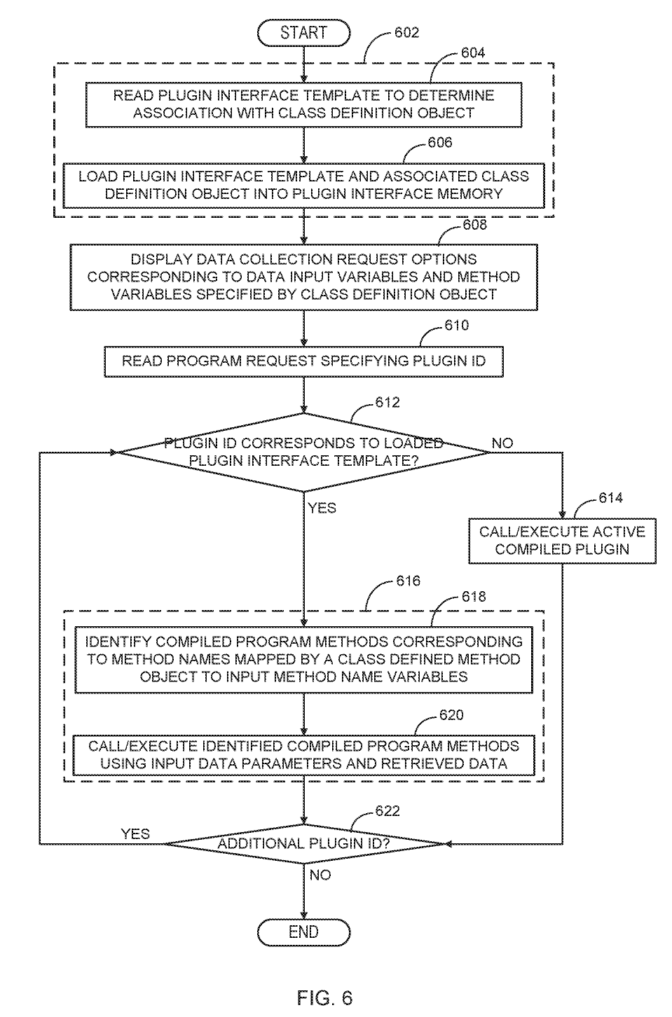

FIG. 6 is a flow diagram illustrating operations and functions performed as part of a data collection cycle to implement data collection workflow extensions in accordance with some embodiments. The operations and functions depicted in FIG. 6 may be performed by one or more of the systems, devices, and components depicted and described with reference to FIGS. 1 and 3. The operations and functions depicted in FIG. 6 may also be performed in conjunction and/or in response to operations and functions depicted and described with reference to FIGS. 4 and 5.

The process begins as shown at super block 602 with one or more client-side, intermediary, and or server-side plugin processing components instantiating a data collection plugin. The instantiation process begins at block 604 with a plugin generator component reading a plugin interface template to determine an association between the plugin interface template and a class definition object. For instance, the plugin generator may initiate the determination in response to detecting a newly generated plugin interface template and the determination may include reading a class definition object ID that is included within a link element of the plugin interface template.

Based, at least in part, on the determined association, the plugin generator completes the instantiation by storing the class definition object and the plugin interface template within a memory space of a plugin interface (block 606). For instance, the plugin generator may transmit the class definition object and the plugin interface template to a plugin engine having a logical memory allocation for plugins. The plugin engine may store the class definition object and plugin interface template received from the plugin generator within the plugin memory.

The process continues as shown at block 608 with a data collection program displaying, via a UI, data collection request options. The request options correspond to data input variables and method name variables specified by one or more class definition objects. At block 610, during runtime processing of a data collection program that includes the data collection UI, a report application or other recipient application receives a data collection request that includes a plugin ID. As shown at blocks 612 and 614, in response to determining that the plugin ID corresponds to a compiled program plugin rather than to a plugin interface template, a plugin wrapper calls and a plugin processor executes the plugin and control passes to block 622.

If the plugin wrapper determines at block 612 that the plugin ID corresponds to a plugin interface template, a data collection plugin an interface plugin execution sequence is performed as shown at superblock 616. The execution sequence begins at block 618 with the plugin wrapper in conjunction with a plugin processor identifying compiled program methods that correspond to method names mapped by a class-defined method object to method name variables. At block 620, the plugin processor executes the identified compiled program language methods using the input data parameters and method parameters included in the request that was received at block 610. Following direct execution of a compiled plugin (block 614) or interfaced execution of a script language plugin (block 620), control passes to block 622. In response to determining at block 622 that the request read at block 610 includes an additional plugin ID, control returns to block 612 to begin another plugin execution cycle. The process ends in response to determining that all plugin IDs have been processed.

### VARIATIONS

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

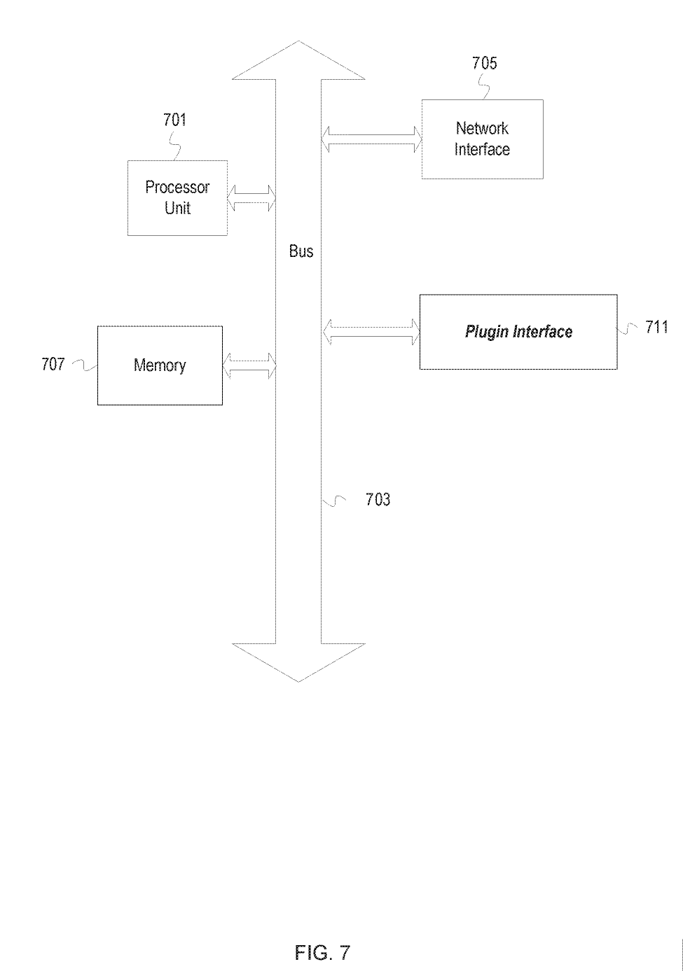

FIG. 7 depicts an example computer system that implements data collection plugin generation and processing in accordance with some embodiments. The computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes a plugin interface 711 such as may incorporate the systems, devices, and components depicted and described with reference to FIGS. 1-6. The plugin interface 711 provides program structures for generating plugins, generating and processing data collection requests, and processing data collection plugins as depicted and described with reference to FIGS. 1-6. To this end, the plugin interface 711 may incorporate and/or utilize some or all of the system, devices, components, and data structures described in FIGS. 1-6.

Any one of the previously described functionalities may be partially (or entirely) implemented in hardware and/or on the processor unit 701. For example, the functionality may be implemented with an application specific integrated circuit, in logic implemented in the processor unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701 and the network interface 705 are coupled to the bus 703. Although illustrated as being coupled to the bus 703, the memory 707 may be coupled to the processor unit 701.

While the aspects of the disclosure are described with reference to various implementations and exploitations, it will be understood that these aspects are illustrative and that the scope of the claims is not limited to them. In general, techniques for implementing data collection workflow extensions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method for implementing program extensions, said method comprising:
instantiating a plugin from a class definition object and a plugin interface template, wherein the plugin interface template comprises a markup language object that describes the class definition object which defines a class that specifies properties of program language objects, and wherein the plugin interface template includes a link to the defined class, said instantiating including,
reading the plugin interface template to determine an association between the plugin interface template and the class definition object; and
based, at least in part, on the determined association, storing the class definition object and the plugin interface template within a memory space of a plugin interface that performs plugin processing for a data collection program; and
executing, by the plugin interface, the plugin including in response to a request from the data collection program specifying a plugin identifier (ID) corresponding to the plugin interface template and further specifying one or more input data parameters and one or more method parameters,
accessing one or more method objects that are specified by a script language method object defined by the class and that correspond to the method parameters; and
executing at least one of the one or more method objects using the input data parameters.

2. The method of claim 1, wherein said plugin interface includes a plugin wrapper comprising wrapper code for calling plugins, and wherein the request from the program comprises a plugin call, said executing the plugin further comprising:
in response to receiving from the plugin call, executing, by the plugin wrapper, a call to the class definition object; and
wherein said executing the one or more method objects comprises calling one or more compiled program language methods corresponding to the one or more method objects.

3. The method of claim 1, wherein the one or more method objects comprise compiled program language objects, and wherein said accessing and executing are implemented by a plugin processor within the plugin interface calling the one or more method objects based on the plugin processor processing the script language method object using the one or more input data parameters and one or more method parameters.

4. The method of claim 1, wherein the plugin interface template maps a program input parameter variable to an input parameter variable specified by the defined class.

5. The method of claim 4, wherein the plugin interface template maps a program method variable to a method variable specified by the defined class.

6. The method of claim 1, further comprising:
displaying a user interface (UI) object comprising at least one UI input object that is logically associated with the plugin interface template; and
wherein said executing the plugin further comprises generating the request including in response to receiving, from a user interface, parameters associated with data to be collected during a data collection cycle, generating the request to include the one or more input data parameters and the one or more method parameters.

7. The method of claim 1, wherein said executing the plugin further comprises, in response to the request, determining a correspondence between the class and the request including:
reading plugin IDs specified within one or more plugin interface templates;
comparing the plugin ID specified within the request with one or more of each of the plugin IDs specified within the plugin interface templates; and
determining a correspondence between the plugin ID specified within the request and a plugin ID specified within one of the plugin interface templates.

8. The method of claim 1, wherein the program executes a data collection cycle, said method further comprising:
retrieving, by the program, data from a data source; and
executing, by the program and a plugin processor within the plugin interface, the plugin to process the retrieved data in accordance with at least one of the one or more method objects.

9. The method of claim 1, wherein determining an association between the plugin interface template and the class definition object includes reading, within an instance of the plugin interface template, a link that identifies the class definition object.

10. One or more non-transitory machine-readable media comprising program code for implementing program extensions, the program code to:
instantiate a plugin from a class definition object and a plugin interface template, wherein the plugin interface template comprises a markup language object that describes the class definition object which defines a class that specifies properties of program language objects, and wherein the plugin interface template includes a link to the defined class, said instantiating including,
reading the plugin interface template to determine an association between the plugin interface template and the class definition object; and
based, at least in part, on the determined association, storing the class definition object and the plugin interface template within a memory space of a plugin interface that performs plugin processing for a data collection program; and
execute, by the plugin interface, the plugin including in response to a request from the data collection program specifying a plugin identifier (ID) corresponding to the plugin interface template and further specifying one or more input data parameters and one or more method parameters,
accessing one or more method objects that are specified by a script language method object defined by the class and that correspond to the method parameters; and
executing at least one of the one or more method objects using the input data parameters.

11. The machine-readable media of claim 10, wherein said plugin interface includes a plugin wrapper comprising wrapper code for calling plugins, and wherein the request from the program comprises a plugin call, said executing the plugin further comprising:
in response to receiving from the plugin call, executing, by the plugin wrapper, a call to the class definition object; and
wherein said executing the one or more method objects comprises calling one or more compiled program language methods corresponding to the one or more method objects.

12. The machine-readable media of claim 10, wherein the one or more method objects comprise compiled program language objects, and wherein said accessing and executing are implemented by a plugin processor within the plugin interface calling the one or more method objects based on the plugin processor processing the script language method object using the one or more input data parameters and one or more method parameters.

13. The machine-readable media of claim 10, wherein the plugin interface template maps a program input parameter variable to an input parameter variable specified by the defined class.

14. The machine-readable media of claim 13, wherein the plugin interface template maps a program method variable to a method variable specified by the defined class.

15. The machine-readable media of claim 10, wherein the program code further comprises program code to:
display a user interface (UI) object comprising at least one UI input object that is logically associated with the plugin interface template; and
wherein said executing the plugin further comprises generating the request including in response to receiving, from a user interface, parameters associated with data to be collected during a data collection cycle, generating the request to include the one or more input data parameters and the one or more method parameters.

16. An apparatus comprising:
a processor; and
a machine-readable medium having program code executable by the processor to cause the apparatus to,
instantiate a plugin from a class definition object and a plugin interface template, wherein the plugin interface template comprises a markup language object that describes the class definition object which defines a class that specifies properties of program language objects, and wherein the plugin interface template includes a link to the defined class, said instantiating including,
reading the plugin interface template to determine an association between the plugin interface template and the class definition object; and
based, at least in part, on the determined association, storing the class definition object and the plugin interface template within a memory space of a plugin interface that performs plugin processing for a data collection program; and
execute, by the plugin interface, the plugin including in response to a request from the data collection program specifying a plugin identifier (ID) corresponding to the plugin interface template and further specifying one or more input data parameters and one or more method parameters,
accessing one or more method objects that are specified by a script language method object defined by the class and that correspond to the method parameters; and
executing at least one of the one or more method objects using the input data parameters.

17. The apparatus of claim 16, wherein said plugin interface includes a plugin wrapper comprising wrapper code for calling plugins, and wherein the request from the program comprises a plugin call, said executing the plugin further comprising:
in response to receiving from the plugin call, executing, by the plugin wrapper, a call to the class definition object; and
wherein said executing the one or more method objects comprises calling one or more compiled program language methods corresponding to the one or more method objects.

18. The apparatus of claim 16, wherein the one or more method objects comprise compiled program language objects, and wherein said accessing and executing are implemented by a plugin processor within the plugin interface calling the one or more method objects based on the plugin processor processing the script language method object using the one or more input data parameters and one or more method parameters.

19. The apparatus of claim 16, wherein the plugin interface template maps a program input parameter variable to an input parameter variable specified by the defined class.

20. The apparatus of claim 19, wherein the plugin interface template maps a program method variable to a method variable specified by the defined class.
